(19) United States
(12) Patent Application Publication
(10) Pub. No.: US 2012/0050154 A1
(43) Pub. Date: Mar. 1, 2012

(54) METHOD AND SYSTEM FOR PROVIDING 3D USER INTERFACE IN 3D TELEVISIONS

(76) Inventor: Adil Jagmag, Hollis, NH (US)

(21) Appl. No.: 12/872,934

(22) Filed: Aug. 31, 2010

(51) Int. Cl. G09G 5/00; H04N 13/02

(52) U.S. Cl. 345/156; 348/46; 348/E13.074

(57) ABSTRACT

A three-dimensional (3D) video device may provide an interactive 3D user interface (UI). This may be achieved by generating 3D video data representative of the 3D user interface; displaying the 3D user interface using the generated 3D video data such that the displayed 3D user interface may create a 3D perception within the proximity of a user; tracking spatial and/or temporal movement of the user relative to the displayed 3D user interface to determine user input and/or feedback; and controlling operation of the 3D video processing device based on the tracking. The generated 3D video data may comprise stereoscopic left view and right view sequences, and it may be generated based on determination of a location and/or orientation of the user relative to the 3D video device. One or more auxiliary devices communicatively coupled to the 3D video device may be utilized to enable viewer perception and/or interaction with the 3D user interface.

### CROSS-REFERENCE TO RELATED APPLICATIONS/INCORPORATION BY REFERENCE

[Not Applicable].

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for providing 3D user interface in 3D televisions.

### BACKGROUND OF THE INVENTION

Display devices, such as television sets (TVs), may be utilized to output or playback audiovisual or multimedia streams, which may comprise TV broadcasts, telecasts and/or localized Audio/Video (AV) feeds from, for example, player devices, such as videocassette recorders (VCRs) and/or Digital Video Disc (DVD) players. Television broadcasts are generally transmitted by television head-ends over broadcast channels, via RF carriers or wired connections. TV head-ends may comprise terrestrial TV head-ends, Cable-Television (CATV), satellite TV head-ends and/or broadband television head-ends. TV Broadcasts may utilize analog and/or digital modulation format. In digital television (DTV) systems, television broadcasts may be communicated via discrete (digital) signals, utilizing one of available digital modulation schemes, which may comprise, for example, QAM, VSB, QPSK and/or OFDM. Use of digital television signals may enable broadcasters to provide high-definition television (HDTV) broadcasting and/or to provide other non-television related services via the digital system. Available digital television systems comprise, for example, ATSC, DVB, DMB-T/H and/or ISDN based systems. Video and/or audio information, whether carried via TV broadcasts and/or storage devices (such as DVD or Blu-ray discs), may be encoded utilizing various video and/or audio encoding and/or compression algorithms, which may comprise, for example, MPEG-1/2, MPEG-4 AVC, MP3, AC-3, AAC and/or HE-AAC. TV broadcasts and/or audiovisual or multimedia feeds may be inputted directly into the TVs, or it may be passed intermediately via one or more specialized devices, such as set-top boxes, which may perform some of the necessary processing operations and/or some additional operations, such as decryption and/or access control operations. Exemplary types of connectors that may be used to input data into TVs include, but not limited to, F-connectors, S-video, composite and/or video component connectors, and/or, more recently, High-Definition Multimedia Interface (HDMI) connectors.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for 3D user interface in 3D televisions, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video system that may be operable to provide communication of 3D video content, which may be utilized in accordance with an embodiment of the invention.

FIG. 2 is a block diagram illustrating an exemplary 3D television (TV) that may be utilized to provide interactive 3D user interface (UI), in accordance with an embodiment of the invention.

FIG. 3 is a block diagram illustrating an exemplary video processing system that may be utilized to provide interactive 3D user interface (UI), in accordance with an embodiment of the invention.

FIG. 4 is a flow chart that illustrates exemplary steps for providing an interactive 3D user interface, in accordance with an embodiment of the invention.

### DETAILED DESCRIPTION OF THE INVENTION

Certain embodiments of the invention may be found in a method and system for providing 3D user interface in 3D televisions. In various embodiments of the invention, a video processing device that handles three-dimensional (3D) video content may provide an interactive 3D user interface (UI) to enable user interaction. In this regard, the video processing device may generate 3D video data representative of the 3D-UI, and the generated 3D video data may be presented by a display device that displays video processed by the video processing device. In this regard, displaying the 3D-UI via the display device may create a 3D perception within proximity of a user. The interactive 3D-UI may receive user input and/or feedback, which may be used to control operations of the video processing device. In this regard, user input and/or feedback may be determined based on user interactions with the interactive 3D-UI. For example, user interactions may be determined based on spatial and/or temporal tracking of movement by the user relative to the interactive interface as perceived by the user. The generated 3D video data may comprise stereoscopic left view and right view sequences of reference fields or frames. The generated 3D video data may be composited with other video content handled via the video processing device such that images corresponding to the interactive 3D-UI may be overlaid on and/or blended with at least a portion of images corresponding to the other handled video content.

The video processing device may determine a location of the user relative to the display device, and the 3D-UI video data may be generated based on the determined user location such that a location of the interactive 3D-UI is configured to create depth perception for the 3D-UI at a location near the determined location of the user. Determining location of the user, and/or the spatial and/or temporal tracking of movement by the user may be performed based on information generated by one or more sensors coupled to the video processing device. Determining the location of the user, and/or the spatial and/or temporal tracking of movement by the user may also be performed based on information provided by the user, and/or by one or more auxiliary devices used by the user in conjunction with use of the video processing device and/or the display device. In this regard, the auxiliary devices may generate and/or communication data corresponding to their location, position, and/or orientation, which may then be correlated by the video processing device with the location of the perceived 3D-UI to enable determining user interactions. The auxiliary devices may also be operable to directly determine the location of the user, and/or to track spatial and/or temporal movement by the users. Accordingly, the auxiliary devices may be utilized to track and/or determine actions of the users relative to the perceived interactive 3D-UI, and the auxiliary devices may communicate this data to the video processing device to enable determining the user input and/or feedback accordingly. Exemplary auxiliary devices may comprise an optical viewing device for 3D video viewing (e.g. 3D glasses), a remote control, and/or a motion tracking glove. In this regard, the motion tracking glove be operable to, when worn by the user, track its absolute or relative location, depth, and/or orientation, and/or any actions performed by the user, such as any clicking or pressing actions. The video processing device may communicate with the one or more auxiliary devices via one or more wireless interfaces. Exemplary wireless interfaces may comprise wireless personal area network (WPAN) interfaces and/or wireless local area network (WLAN) interfaces.

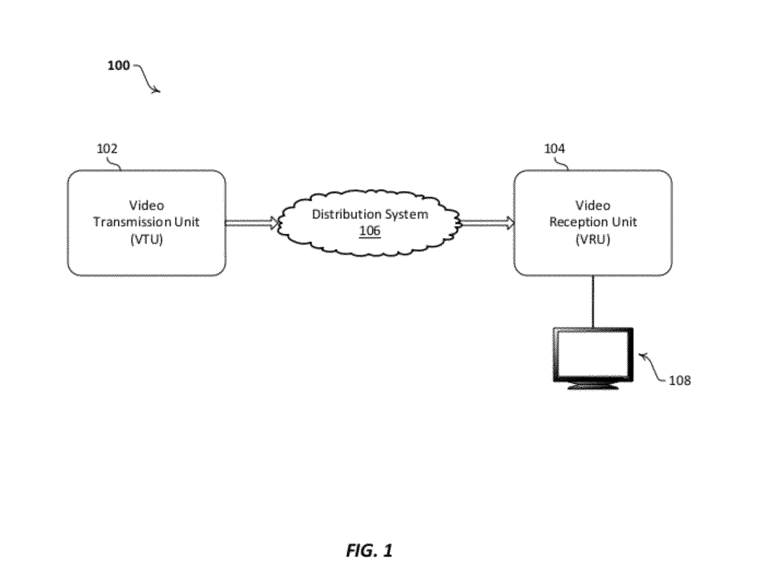

FIG. 1 is a block diagram illustrating an exemplary video system that may be operable to provide communication of 3D video content, which may be utilized in accordance with an embodiment of the invention. Referring to FIG. 1, there is shown a video system 100, which may comprise a video transmission unit (VTU) 102, a video reception unit (VRU) 104, a distribution system 106, and a display device 108.

The video system 100 may be operable to support three-dimensional (3D) video. In this regard, various multimedia infrastructures, such as digital TV (DTV) and/or DVD/Blu-ray for example, may generate, display, and/or cause to be displayed, 3D video which may be more desirable since 3D perception is more realistic to humans. Various techniques may be utilized to capture, generate (at capture and/or playtime) and/or render 3D video images. In this regard, one of the more common techniques for implementing 3D video is stereoscopic 3D video. In stereoscopic 3D video based applications the 3D video impression may be generated by rendering multiple views, most commonly two views: a left view and a right view, corresponding to the viewer's left eye and right eye, to give depth to displayed images. The left view and the right view sequences may be captured and/or processed to enable the creation of 3D images. The video data corresponding to the left view and right view sequences may then be communicated either as separate streams, or may be combined into a single transport stream and would be separated into different view sequences by the end-user receiving/displaying device. The 3D video content may communicated via TV broadcasts. The communication of 3D video content may also be performed by use of multimedia storage devices, such as DVD or Blu-ray discs, which may be utilized to store 3D video data that may subsequently be played back via an appropriate device, such as an audio-visual (AV) player device like DVD or Blu-ray players. Various compression/encoding standards may be utilized to enable compressing and/or encoding of the view sequences into transport streams during communication of 3D video content. For example, in instances where stereoscopic 3D video is utilized, the separate left and right view sequences may be compressed based on MPEG-2 MVP, H.264 and/or MPEG-4 advanced video coding (AVC) or MPEG-4 multi-view video coding (MVC).

The VTU 102 may comprise suitable logic, circuitry, interfaces and/or code that may be operable to provide encoded and/or compressed video data, via the distribution system 106 for example, to one or more of the VTU 104 to facilitate display and/or video playback operations. The VTU 102 may be operable to encode 3D video contents as well as 2D video contents. For example, in instances where 3D video content is generated as stereoscopic 3D video, the VTU 102 may be operable to encode the 3D video as stereoscopic view streams comprising, for example, a left view video sequence and a right view video sequence, of which each may be transmitted in a different channel to the VRU 104. The video content generated via the VTU 102 may be broadcasted to the VRU 104 via the distribution system 106. Accordingly, the VTU 102 may comprise a terrestrial-TV head-end, a cable-TV (CATV) head-end, a satellite-TV head-end and/or a web server that may provide broadband-TV transmission via the Internet, for example. Alternatively, the video content may be stored into multimedia storage devices, such as DVD or Blu-ray discs, which may be distributed via the distribution system 106 for playback via the VRU 104.

The VRU 104 may comprise suitable logic, circuitry, interfaces and/or code that may be operable to receive and/or process video contents, which may comprise 2D as well as 3D video content. Accordingly, the VRU 104 may be operable to handle 3D video content, to enable displaying via the display device 108, for example. The 3D content handled by the VRU 104 may comprise, for example, stereoscopic 3D video, which may be received in the form of encoded stereoscopic view streams. In this regard, the VRU 104 may be operable to decode the encoded stereoscopic 3D video sequences, and generated corresponding video output streams for display that may create 3D perception. The video content may be received, by the VRU 104, in the form of transport streams, which may be communicated directly by, the VTU 102 for example, via DTV broadcasts. In this regard, the VRU 104 may be a set-top box. The transport stream may comprise encoded 3D video corresponding to, for example, stereoscopic 3D video sequences. In this regard, the VRU 104 may be operable to demultiplex or parse the received transport stream, based on user profile, user input, and/or predetermined configuration parameter(s), for example. The encoded stereoscopic 3D video sequences may be extracted from the received transport stream and may be stored in a memory or a local storage of VRU 104.

The VRU 104 may also be operable to receive and/or process video content communicated by the VTU 102 via multimedia storage devices, such as DVD or Blu-ray discs. In this regard, the VRU 104 may comprise an appropriate audio/video (AV) player device and/or subsystem, such as Blu-ray or DVD players, which may enable reading video data from the multimedia storage devices. In some instances, the VRU 104 may be operable to convert 3D video into a 2D video for display. Accordingly, the VRU 104 may comprise a function in a display device, such in the display device 102; a dedicated intermediate device, such as a set-top box, a personal computers, or an AV player; and/or any combination thereof.

The distribution system 106 may comprise suitable logic, circuitry, interfaces and/or code that may be operable to provide platforms and/or mediums for communicating of video data, between the VTU 102 and the VRU 104 for example. In instances where the video data is communicated directly, via TV broadcasts for example, the distribution system 106 may comprise one or more wired and/or wireless networks. In this regard, the distribution system 106 may comprise cable networks, local area network, wide area network, the Internet, and the like. In instances where the video data is communicated indirectly, the distribution system 106 may comprise support infrastructure that may be enable storing video data into media storage devices, such as DVD and/or Blu-ray discs, which may then be distributed to end-users. The media storage devices may then be read via appropriate AV player devices, such DVD or Blu-ray players for example, to enable retrieving the video data that may be played back locally via a display device, such as a HDTV set.

The display device 108 may comprise suitable logic, circuitry, interfaces and/or code that enable playing of multimedia streams, which may comprise audio-visual (AV) data. The display device 108 may comprise, for example, a television (such as a HDTV), a monitor, and/or other display and/or audio playback devices, and/or components that may be operable to playback video streams and/or corresponding audio data, which may be received, directly by the display device 108 and/or indirectly via other entities, such as the VRU 104.

In operation, the VTU 102 may be operable to generate, encode and/or compress video content, which may then be communicated to the VRU 104, directly or indirectly via the distribution system 106. The VTU 104 may be operable to receive and process the video content, to facilitate displaying of the received video content via appropriate display devices, such as the display device 108. In this regard, the VTU 104 may be operable to, for example, demultiplex received transport streams to extract encoded video content, and to decode/decompress the video content and to process the decoded video content such that video may be suitable for local display. In an exemplary aspect of the invention, the video system 100 may support three-dimensional (3D) video. In this regard, the VTU 102 may be operable to capture and/or generate 3D video content, and the VRU 104 may be operable to receive and/or handle 3D video content, which may then be displayed via 3D capable display devices, such as display device 108.

The 3D video content used in the video system 100 may comprise 3D stereoscopic video. The 3D video content may communicated in the video system 100 in the form of digital TV (DTV) broadcasts. In this regard, the VTU 102 may communicate 3D video content to the VRU 104, for display via the display device 108. The communication of 3D video may also be performed by use of multimedia storage devices, such as DVD or Blu-ray discs, which may be used to store 3D video data that may be subsequently played back via an appropriate player, such as DVD or Blu-ray player devices. Various compression/encoding standards may be utilized in conjunction with use of 3D video content, for compressing and/or encoding of 3D content into transport streams during communication of the 3D video content. For example, in instances where the 3D video content may comprise stereoscopic view sequences, such as separate left and right view sequences, the view sequences may be compressed based on MPEG-2 MVP, H.264 and/or MPEG-4 advanced video coding (AVC) or MPEG-4 multi-view video coding (MVC).

In various embodiments of the invention, systems and/or devices utilized to display 3D video content, such as the display device 108, may also provide an interactive 3D user interface, to enhance user interactivity during 3D video content viewing for example. In this regard, 3D video data corresponding to a user interface (UI) may be generated, and may be utilized, utilizing 3D processing resources otherwise used for 3D video viewing, to provide 3D perception for the UI. For example, in instances where the VRU 104 and/or the display device 108 support 3D stereoscopic video, left and right view sequences corresponding to an interactive user interface may be generated such that combining these view sequences may result in images corresponding to a 3D UI that may create a depth perception, which may be displayed via the display device 108 for example. In this regard, at least some components and/or subsystems, in the VRU 104 and/or the display device 108 for example, and/or in any additional auxiliary devices which may be used in handling received 3D video content, may also be utilized in facilitating generating and/or creating the 3D perception for the user interface.

The interactive 3D user interface may be used to display information, such as, for example, status and/or current configuration information corresponding to various components, operations and/or functions in the video display device 108 and/or the VRU 104 for example. Furthermore, user interactivity may be enhanced by enabling users to utilize the UI to provide input and/or feedback. In this regard, the generated 3D video data, corresponding to the UI, may comprise data corresponding to input fields and/or means, which the user may utilize to provide input, feedback and/or selections. The 3D-UI may be rendered, for example, based on the generated 3D video data, such that the UI may appear to be spatially projected close to the user. Accordingly, the user may provide the input and/or feedback based on physical interactions with the perceived projected UI. For example, the generated 3D video data may create a 3D perception of keypad and/or keyboard that may appear to be rendered close to the user such that the user may provide input and/or feedback, using hands and/or figures for example, to seemingly enter the information and/or responses on the perceived keypad or keyboard that is projected as part of the UI.

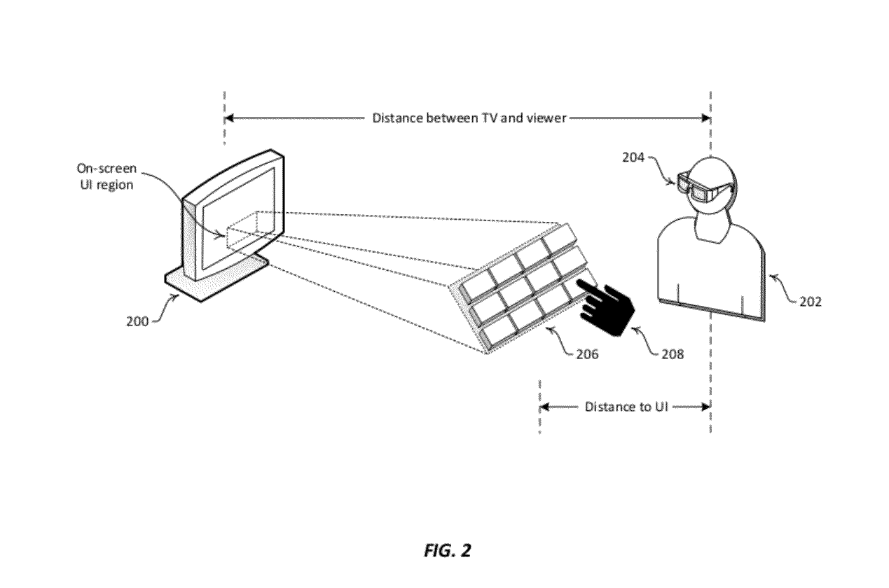

FIG. 2 is a block diagram illustrating an exemplary 3D television (TV) that may be utilized to provide interactive 3D user interface (UI), in accordance with an embodiment of the invention. Referring to FIG. 2, there is shown a display device 200, a user 202, and 3D glasses 204.

The display device 200 may be similar to the display device 108, substantially as described with regard to FIG. 1. In this regard, display device 200 may comprise suitable logic, circuitry, interfaces and/or code that may be operable to display video content, including 3D video, and outputting additional related information and/or data, such as audio for example. The display device 200 may provide 3D viewing independently and/or by use of additional auxiliary devices, including specialized optical viewing devices, such as the 3D glasses 204, for example.

The 3D glasses 204 may comprise suitable logic, circuitry, interfaces and/or code that may be operable to provide 3D viewing in conjunction with 3D-capable display devices. For example, in instances where the display 200 is utilized to display stereoscopic 3D video content, which may comprise left and right view sequences, the 3D glasses 204 may be utilized to enable 3D perception by providing independent image perception by user's left and right eyes such that the combined effects may generate 3D perception. The viewing settings and/or operations via the 3D glasses 204 may be configured and/or synchronized with the display and/or playback operations, via the display 200 for example, to ensure that desired 3D results may be produced.

In operation, the display device 200 may be utilized to display 3D video. In this regard, the display device 200 may obtain 3D video content from local sources or feeds, such as via AV player devices, and/or from 3D TV broadcasts, such as cable or satellite 3D TV broadcast. The received 3D video content may be processed, via the display device 200 and/or additional dedicated processing devices, to enable generating corresponding 3D images that maybe displayed via the display device 200. In this regard, the display device 200 may provide 3D viewing experience, to user 202, independently without necessitating use of other devices to create the 3D perception. For example, the display device 200 may support auto-stereoscopic 3D video content, which may enable creating 3D perception without the need to use specialized viewing devices, based on, for example, such techniques as lenticular screens. Alternatively, perceiving the 3D images, by the user 202, and/or creating the 3D perception may necessitate use of auxiliary devices, such as specialized stereoscopic glasses like the 3D glasses 204 for example.

In an exemplary aspect of the invention, the display device 200 may provide interactive 3D user interface services, substantially as described with regard to FIG. 1 for example. In this regard, 3D video data corresponding to an interactive 3D user interface may be generated, such that this video data may be utilized, via the display device 200, to create render a 3D perception of an interactive user interface close to the user 202. For example, the generated 3D video data may comprise left and right view sequences, which when combined, may create, for example, a perception of a projected 3D keyboard 206 close to the user 202. The user 202 may then provide input and/or feedback by ‘pressing’ buttons on the projected keyboard 206. Perceiving the projected keyboard 206 may be achieved by use of, for example, the 3D glasses 204.

Various considerations may be relevant to the generation and/or use of the user interface 3D video data. For example, to ensure that the 3D user interface is rendered properly, the location and/or orientation of the user 202, relative to the display device 200 (or the screen therein) may be determined. This may enable ensuring that the rendered 3D user interface has proper depth, and/or is projected in a manner that may enable the user 202 to perceive the user interface as 3D object. In this regard, various mechanisms and/or techniques may be utilized to determine the location and/or orientation of the user 202. For example, location and/or orientation data may be provided directly by the user 202 and/or preconfigured by the user 202 into the display device 200. The location and/or orientation data may also be provided by auxiliary devices that are used by the user 202 during 3D viewing via the display device 200. For example, in instances where the 3D glasses 204 are utilized by the user 202, the 3D glasses 204 may communicate with the display device 200 to provide, directly or indirectly, location and/or orientation data. The display device 200 may also be operable to autonomously determine location and/or orientation of the user 202, using, for example, optical and/or infrared scanners, Z-depth sensors, and/or biometric sensors, which may be coupled to and/or integrated into the display device 200 for example. Once the location and/or orientation of the user 202 are determined, the location and/or depth of the interactive UI, relative to the user 202, may also be determined. In this regard, the perceived location and/or depth of the projected keyboard 206 may be determined, based on predetermined generic distance criteria, which may dictate the average separation between users and the UI. Alternatively, user profiles may be maintained that may be utilized to uniquely configure location of the projected UI relative to each user.

Once the 3D user interface is rendered, user's input and/or feedback may be obtained by, for example, tracking user interactions with the 3D user interface, such as tracking user 202 interactions with the projected keyboard 206, for example. Various mechanisms and/or techniques may be utilized to spatially and/or temporally track user 202, and/or interactions thereby in conjunction with the rendered 3D user interface. In this regard, user tracking may be determined based on three-dimensional movement data, which may be generated and/or estimated based on temporal sequences of 3D coordinates (i.e. horizontal, vertical and depth parameters) of tracked reference points corresponding to the user, and/or user's hands or fingers. For example, the display device 200 may be operable to track movement and/or actions by the user 202, using, for example, biometric sensors. The display device 200 may track hand motion of the user 202, and/or any additional specialize actions such as pressing or clicking motions, using biometric sensory devices to determine whether the user 202 is attempting to provide input or feedback via the projected keyboard 206.

User interactions may also be determined based on information provided by auxiliary devices, which may be utilized by the user 202 to interact with projected 3D user interface. For example, the 3D glasses 204, which may be utilized in viewing content rendered via the display device 200, may also be operable determine the location and/or orientation of the user 202, based on its own location and/or orientation for example, and/or to track spatial and/or temporal movement by the user 202. Accordingly, the 3D glasses 204 continually generate and communicate information regarding location and/or movement by the user during viewing operations to the display device 200. In some embodiments, the 3D glasses 204 may also be utilized to autonomously track and/or determine actions of the user 202, such as determining whether ‘pressing’ or ‘clicking’ actions were performed, relative to perceived 3D user interfaces such as the projected keypad 206 for example, and may communicate this information to the display device 200 to enable determining the user input and/or feedback accordingly. In some embodiments of the invention, the user 202 may also use a specialized glove 208 to interact with the projected keyboard 206. In this regard, the glove 208 may be operable to track its location and/or orientation, and/or any actions performed by the user 202, such as any clicking or pressing actions. In this regard, the glove 208 may track its motion relative to a known position and/or location corresponding to the user 202. The glove 208 may, for example, track its location, position, and/or orientation relative to the 3D glasses 204 for example. The glove 208 may communicate with the display device 200, directly and/or indirectly, via the 3D glasses 204, for example. Accordingly, the glove 208 may continually provide location, movement, and/or action related data that may be utilized, via the display device 200, to evaluate and/or determine user 202 interactions with, for example, the projected keyboard 206. Once the display device 200 receives user location, motion and/or action information, the display 200 may determine the input and/or feedback provided by the user 202 by correlating the received user movement and/or actions with the location of the projected keyboard 206. This may also allow the display device 200 to ascertain and/or guard against unrelated movement, in instances where the user's actions may be determined not to be at what should be perceived depth of the 3D user interface.

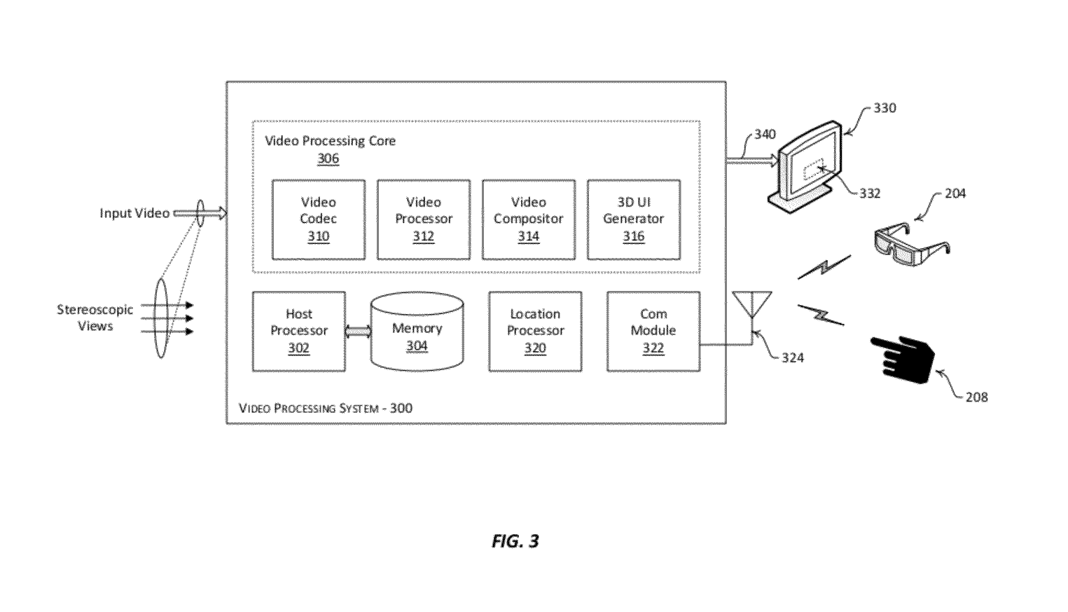

FIG. 3 is a block diagram illustrating an exemplary video processing system that may be utilized to provide interactive 3D user interface (UI), in accordance with an embodiment of the invention. Referring to FIG. 3, there is shown a video processing system 300, a display system 330, and the 3D glasses 204.

The video processing system 300 may comprise suitable logic, circuitry, interfaces and/or code that may enable processing of video content, and/or generating video playback streams based thereon for display, via the display system 300 for example. In this regard, the video processing system 300 may comprise a host processor 302, a system memory 304, a video processing core 306, a location processor 320, a communication module 322, and an antenna subsystem 324. In an exemplary aspect of the invention, the video processing system 300 may provide interactive 3D user interfacing, substantially as described with regard to FIG. 2. In this regard, the video processing system 300 may be integrated into the display device 200, for example, to enable generating, displaying, and/or controlling a 3D user interface.

The host processor 302 may comprise suitable logic, circuitry, interfaces and/or code that may be operable to process data, and/or control and/or manage operations of the video processing system 300, and/or tasks and/or applications performed therein. In this regard, the host processor 302 may be operable to configure and/or control operations of various components and/or subsystems of the video processing system 300, by utilizing, for example, one or more control signals. The host processor 302 may also control data transfers within the video processing system 300. The host processor 302 may enable execution of applications, programs and/or code, which may be stored in the system memory 304, for example. The system memory 304 may comprise suitable logic, circuitry, interfaces and/or code that may enable permanent and/or non-permanent storage, buffering and/or fetching of data, code and/or other information which may be used, consumed and/or processed in the video processing system 300. In this regard, the system memory 304 may comprise different memory technologies, including, for example, read-only memory (ROM), random access memory (RAM), Flash memory, solid-state drive (SSD) and/or field-programmable gate array (FPGA). The system memory 304 may store, for example, configuration data, which may comprise parameters and/or code, comprising software and/or firmware, but the configuration data need not be limited in this regard.

The video processing core 306 may comprise suitable logic, circuitry, interfaces and/or code that may be operable to perform video processing operations. The video processing core 306 may be operable to process input video streams, which may comprise 3D stereoscopic views, received via the video processing system 300. The video processing core 306 may be operable to generate corresponding output video streams 324, which may be playback via the display system 330. In an exemplary aspect of the invention, the video processing core 306 may also support use of interactive 3D user interface, (UI), substantially as described with regard to FIG. 2. The video processing core 306 may comprise, for example, a video encoder/decoder (CODEC) 310, a video processor 312, a video compositor 314, and a 3D user interface (UI) generator 316.

The video CODEC 310 may comprise suitable logic, circuitry, interfaces and/or code for performing video encoding and/or decoding. For example, the video CODEC 310 may be operable to process received encoded/compressed video content, by performing, for example, video decompression and/or decoding operations. The video CODEC 310 may also be operable to encode and/or format video data which may be generated via the video processing core 306, as part of the output video stream 340. The video CODEC may be operable to decode and/or encode video data formatted based on based on one or more compression standards, such as, for example, H.262/MPEG-2 Part 2, H.263, MPEG-4 Part 2, H.264/MPEG-4 AVC, AVS, VC1 and/or VP6/7/8. In an exemplary aspect of the invention, the video CODEC 310 may also support video coding standards that may be utilized in conjunction with 3D video, such as MPEG-2 MVP, H.264 and/or MPEG-4 advanced video coding (AVC) or MPEG-4 multi-view video coding (MVC). In instances where the compressed and/or encoded video data is communicated via transport streams, which may be received as TV broadcasts and/or local AV feeds, the video CODEC 310 may be operable to demultiplex and/or parse the received transport streams to extract video data within the received transport streams. The video CODEC 310 may also perform additional operations, including, for example, security operations such as digital rights management (DRM).

The video processor 312 may comprise suitable logic, circuitry, interfaces and/or code that may be operable to perform video processing operations on received video data, after it has been decoded and/or decompressed, to facilitate generation of corresponding output video data, which may be played via, for example, the display system 330. In this regard, the video processor 312 may be operable to perform such operations as de-noising, de-blocking, restoration, deinterlacing and/or video sampling.

The video compositor 314 may comprise suitable logic, circuitry, interfaces and/or code that may be generate output video data for display based on video content received and processed via the video processing core 306. The video compositor 314 may also be operable to combine the video data corresponding to received video content with additional video data, such as video data corresponding to on-screen graphics, secondary feeds, and/or user interface related video data. Furthermore, the video compositor 314 may perform additional video processing operations, to ensure that generated output video steams may be formatted to suit the display system 330. In this regard, the video compositor 314 may be operable to perform, for example, motion estimation and/or compensation, frame up/down-conversion, cropping, and/or scaling.

The 3D-UI generator 316 may comprise suitable logic, circuitry, interfaces and/or code that may be operable to generate user interface related video data, which be composited and/or incorporated into the output video stream 340. In this regard, the corresponding user interface, resulting from the generated 3D video data, may display configuration and/or status information, and/or may also allow users to provide feedback and/or control or setup input. In an exemplary aspect of the invention, the generated video data may enable providing 3D perception of the corresponding user interface. In this regard, the 3D-UI generator 316 may generate stereoscopic 3D video based left and right view sequences corresponding to the user interface, which may then be forwarded to the video compositor 314 to be combined with other video data being outputted to the display system 330. The 3D-UI generator 316 may utilize the video CODEC 310 to performing any necessary 3D video encoding operations.

The location processor 320 may comprise suitable logic, circuitry, interfaces and/or code that may be operable to perform location and/or tracking related operations. In this regard, the location processor 320 may be operable to determine location of users, perceived location of where the UI, which may be used in controlling the generation of corresponding 3D video data, and/or for tracking viewer interactions with the projected 3D user interface. While the location processor 320 is shown as a separate component within the video processing system 300, the invention need not be so limited. For example, the location processor 320 may be integrated into other components of the video processing system 300, and/or functions or operations described herein with respect to the location processor 320 may be performed by other components of the video processing system 300, such as the host processor 302 for example.

The communication module 322 may comprise suitable logic, circuitry, interfaces and/or code that may be operable to provide communication links between the video processing system 300 and one or more auxiliary devices, which may be communicatively coupled to and/or be operated in conjunction with the video processing system 300, such as the 3D glasses 204 and/or the glove 208. In this regard, the communication module 322 may be operable to process signals transmitted and/or received via, for example, the antenna subsystem 324. The communication module 322 may be operable, for example, to amplify, filter, modulate and/or demodulate, and/or up-convert and/or down-convert baseband signals to and/or from RF signals to enable transmitting and/or receiving RF signals corresponding to one or more wireless standards. Exemplary wireless standards may comprise wireless personal area network (WPAN), wireless local area network (WLAN), and/or proprietary based wireless standards. In this regard, the communication module 322 may be utilized to enable communication via Bluetooth, ZigBee, 60 GHz, Ultra-Wideband (UWB) and/or IEEE 802.11 (e.g. WiFi) interfaces.

The antenna subsystem 324 comprises suitable logic, circuitry, interfaces and/or code that may enable transmission and/or reception of RF signals via one or more antennas that may be configurable for RF communication based on one or more RF bandwidths, which may correspond to wireless interfaces supported by the communication module 322. For example, the antenna subsystem 324 may enable RF transmission and/or reception via the 2.4 GHz bandwidth which is suitable for Bluetooth and/or WiFi RF transmissions and/or receptions.

The display system 330 may comprise suitable logic, circuitry and/or code that may enable displaying of video content, such as the output video stream 340, which may generated via the video processing system 300. The display system 330 and the video processing system 300 may be integrated within a single device, such as the display device 200 for example. Alternatively, the display system 330 and the video processing system 300 may be integrated in different devices which may be coupled together to enable display operations. For example, the display system 330 may correspond to the display device 200 for example whilst the video processing system 300 may be integrated within a separate device, such as a set-top box or and audio-visual (AV) player device, which may be connected to the display device 200, to enable 3D video playback operations for example.

In operation, the video processing system 300 may be operable to support video playback operations, to facilitate, for example, displaying of images corresponding to received and/or generated video data. In this regard, the video processing system 300 may be operable to receive video content, and may perform, via the video processing core 306, various video operations on the received video content. Exemplary video operations may comprise video encoding/decoding, ciphering/deciphering, and/or video processing, which may comprise de-noising, de-blocking, restoration, deinterlacing, scaling and/or sampling, to enable generation of the output video stream 340, which may be displayed and/or played back via the display system 330. The video processing system 300 may support 2D as well as 3D video content. In this regard, in instances where the video data handled by the video processing system 300 comprises, for example, stereoscopic 3D video content, the video processing core 306 may be utilized to generate a 3D output stream that may be played and/or viewed via the display system 330. For example, the video processor 312 may generate, based on the video data decoded via the video CODEC 310, corresponding stereoscopic left and right view video sequences, which may be composited via the video compositor 314 into the output stream 340, for display via the display system 330. The display system 330 may enable autonomous 3D viewing, without requiring use of any additional devices. Alternatively, 3D viewing may necessitate use of one or more auxiliary devices, such as the 3D glasses 204.

In various embodiments of the invention, the video processing system 300 may be operable to support an interactive 3D user interface. In this regard, the video processing system 300 may be operable to provide, via the display system 330 for example, interactive 3D user interface services, substantially as described with regard to FIG. 2 for example. For example, 3D video data corresponding to an interactive 3D user interface may be generated via the 3D-UI generator 316, and the 3D video data may be utilized, via the display system 330 for example, to render a 3D perception of an interactive user interface closer to users. The generated 3D video data corresponding to the interactive 3D user interface may be combined, via the video compositor 314 for example, with video data corresponding to processed 3D video content in received input streams, into the output stream 340, such that the 3D-UI video content may be overlaid on and/or blended with the input 3D video content, at a specific UI screen region 332 on the display subsystem 330. For example, in instances where the video processing system 300 utilizes stereoscopic 3D video, the generated 3D-UI video data may comprise left and right view sequences, which may be combined with the corresponding left and right view sequences, respectively, in other 3D video content, to create a perception of projected 3D keyboard 206 by use of, for example, the 3D glasses 204, substantially as described with regard to FIG. 2.

In an exemplary embodiment of the invention, in order to ensure that the 3D user interface that is generated by the 3D-UI generator 316 is rendered properly, the location and/or orientation of users, such as user 202 of FIG. 2, relative to the display system 330 may be determined, using the location processor 320. In this regard, an absolute location and/or orientation data of a user may be communicated to the video processing system 300, via the communication module 322 and/or the antenna subsystem 324 for example, and/or may be processed via the location processor 320 to determine the user location and/or orientation relative to the video processing system 300 and/or the display system 330. In this regard, the user location and/or orientation may be provided by the users, and/or may be provided by auxiliary devices, such as the 3D glasses 204 and/or the glove 208, which may be utilized by users in conjunction with use of the video processing system 300 and/or the display system 330. For example, the 3D glasses 204 may be communicate its location and/or orientation information, which may be correlated with location and/or orientation of users using the 3D glasses 240 in viewing content displayed via the display system 330. The auxiliary devices may be communicatively coupled to the video processing system 300 via, for example, wireless links, such as Bluetooth and/or WiFi links, using the communication module 322 and/or the antenna subsystem 324 for example.

User location and/or orientation may also be determined autonomously, directly via the video processing system 300, by use of suitable sensors that may enable locating the user and/or determining the location and/or orientation of the user relative to the video processing system 300 and/or the display system 330. Exemplary sensors may comprise, for example, optical and/or infrared scanners, Z-depth sensors, and/or biometric sensors (not shown). In this regard, the sensors may be integrated into and/or coupled to the video processing system 300, and may be utilized to locate, identify, and/or track the user, and may provide corresponding data to the video processing system 300. User location and/or orientation data may be utilized, for example, via the 3D-UI generator 316 to determine and/or control location and/or depth of the generated interactive 3D user interface. For example, the perceived location and/or depth of the projected keyboard 206 may be determined based on the determined location and/or orientation of user 202.

The 3D user interface provided via the video processing system 300 may also enable obtaining user input and/or feedback, based on, for example, spatial interactions by the user with the 3D user interface at a location and/or depth of the 3D user interface as perceived by the users. In this regard, the video processing system 300 may correlate, via the location processor 320 for example, the location and/or orientation information corresponding to spatial movements by a user's hands for example, with the location and/or orientation of the projected 3D user interface as perceived by the user. For example, in instances where the projected 3D user interface comprise the keyboard 206, user input and/or feedback may provided based on determining whether the user's hand movements, as determined relative to the location and/or orientation of the projected keyboard 206, constitutes ‘pressing’ or ‘clicking’ of certain buttons on the projected keyboard 206.

Tracking and/or monitoring of user movement and/or actions may be performed autonomously via the video processing system 300. For example, the video processing system 300 may be operable to track a user's hand motions and/or any additional specialized actions, such as ‘pressing’ or ‘clicking’ motions, using biometric sensors for example. Data corresponding to view interactions data and/or information may also be provided by auxiliary devices that may be utilized in conjunction with the video processing system 300 and/or the display system 330. For example, the 3D glasses 204, which may be utilized in viewing content rendered via the display system 330, may also be utilized to track spatial and/or temporal movement by users utilizing the 3D glasses 204 to view content displayed via the display system 330. Accordingly, the 3D glasses 204 may be utilized to track and/or determine actions of users relative to the perceived 3D content including the user interface, based on movements of user's hands or fingers for example, and may communicate this information to the video processing system 300 to enable determining user input and/or feedback. The glove 208 may also be used in interacting with the projected keyboard 206, and accordingly may be utilized to track its location and/or orientation, and/or any actions performed by the user 202, such as any clicking or pressing actions, substantially as described with regard to FIG. 2. The glove 208 may then communicate the data to the video processing system 300, via the communication module 322 and/or the antenna subsystem 324. In an exemplary embodiment of the invention, the video processing system 300 may compare, for example, detected and/or recorded motions and/or actions by the user with a set of predefined actions and/or gestures to enable proper interpretation of the detection actions and/or motions as input or feedback. In this regard, the predefined motions and/or actions may be preconfigured into the video processing system 300 and/or may be defined by the user, as part of system setup and/or initialization procedures.

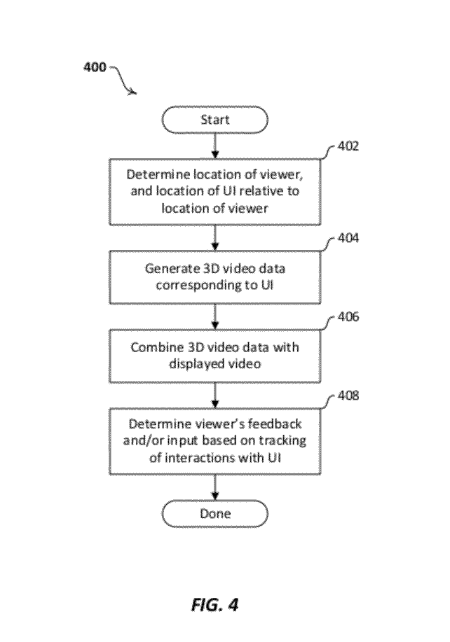

FIG. 4 is a flow chart that illustrates exemplary steps for 3D user interface in 3D televisions, in accordance with an embodiment of the invention. Referring to FIG. 4, there is shown a flow chart 400 comprising a plurality of exemplary steps that may be performed to enable performing 3D user interface in 3D televisions during video processing.

In step 402, the location of a user may be determined, and accordingly the location of the user interface (UI) to be generated, relative to location of user for example, may be determined based thereon. For example, the video processing system 300 may determine a location and/or orientation of the user 202 relative to the display device 200. In this regard, the user location/orientation information may be provided directly by the user indirectly based on auxiliary devices utilized by the user, and/or autonomously by the video processing system 300, using sensory and tracking devices, for example. In step 404, three-dimensional (3D) video data corresponding to the UI may be generated. For example, the 3D-UI generator 316 may generate 3D video data corresponding to the interactive user interface. In step 406, the generated 3D video data corresponding to the UI may be combined with video content to be displayed. For example, the video compositor 314 may combine generated 3D-UI video data with other 3D video data handled and/or processed by the video processing system 300. The combined content may then be displayed, via the display system 330 for example. In step 408, user's feedback and/or input may be determined based on, for example, tracking of the user's interactions with UI.

Various embodiments of the invention may comprise a method and system for a 3D user interface in 3D televisions. The video processing system 300, which may be operable to handle three-dimensional (3D) video content, may provide an interactive 3D user interface (UI). In this regard, the video processing system 300 may generate, via the 3D-UI generator 316, 3D video data representative of the interactive 3D-UI that may be utilized by users to interact with the display system 330, which may be used to display video processed via the video processing system 300. The 3D user interface may be displayed via the display system 330 using the generated 3D video data, wherein displaying the 3D user interface may create a 3D perception, of an interactive interface, within proximity of the users. The interactive 3D-UI may enable obtaining user input and/or feedback, based on user interactions with the interactive 3D-UI. In this regard, user interactions may be determined based on spatial and/or temporal tracking of movement by the user relative to the interactive interface as perceived by the user. The generated 3D video data may comprise stereoscopic left view and right view sequences of reference fields or frames. The generated 3D video data may be composited, via the video compositor 314, with other video content handled via the video processing system 300 such that images corresponding to the interactive 3D-UI may be overlaid on and/or blended with at least a portion of images corresponding to the other handled video content.

The video processing system 300 may determine, via the location processor 320, location, depth, and/or orientation of the user relative to the display system 330 and/or the video processing system 300, and the 3D-UI video data may be generated based on determined user location, depth, and/or orientation such that location of interactive 3D-UI is configured to create depth perception for the 3D-UI at a location near the determined location of the viewer. Determining location of the viewer and/or the spatial and/or temporal tracking of movement by the users, via the location processor 320, may be performed based on information generated by one or more sensors, such as optical or infrared scanner, z-depth sensors, and/or biometric sensor, which may be coupled to and/or integrated into the video processing system 300. Determining location, depth, and/or orientation of the user and/or the spatial and/or temporal tracking of movement by the user may also be performed based on information provided by the user and/or by one or more auxiliary devices used by the viewer in conjunction with use of the video processing system 300 and/or the display system 330. Exemplary auxiliary devices may comprise the 3D glasses 204 and/or the motion tracking glove 208. The video processing system 300 may communicate with the auxiliary devices via one or more wireless interfaces, via the communication module 322 and/or the antenna subsystem 324. Exemplary wireless interfaces may comprise wireless personal area network (WPAN) interfaces and/or wireless local area network (WLAN) interfaces.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for providing 3D user interface in 3D televisions.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
in a three-dimensional (3D) video processing device:
generating 3D video data representative of a 3D user interface;
displaying said 3D user interface using said generated 3D video data, wherein said displaying creates a 3D perception within proximity of a user;
tracking spatial and/or temporal movement of said user relative to said displayed 3D user interface based on said 3D perception; and
controlling operation of said 3D video processing device based on said tracking.

2. The method according to claim 1, wherein said generated 3D video data comprises stereoscopic left view and right view sequences of reference fields or frames.

3. The method according to claim 1, comprising compositing said generated 3D video data with other video content handled via said 3D video processing device such that said 3D user interface is overlaid on at least a portion of images corresponding to said other video content.

4. The method according to claim 1, comprising determining a location of said user relative to said 3D video processing device.

5. The method according to claim 4, comprising generating said 3D video data representative of said 3D user interface such that a perceived location of said 3D user interface is based on said determined location of said user.

6. The method according to claim 4, comprising determining said location of said user, and/or said spatial and/or temporal tracking of movement by said user based on information generated by one or more sensors coupled to said video processing device.

7. The method according to claim 4, comprising determining said location of said user, and/or said spatial and/or temporal tracking of movement by said user based on information provided by said user and/or by one or more auxiliary devices used by said user.

8. The method according to claim 7, wherein said one or more auxiliary devices comprise an optical viewing device for 3D video viewing, a remote control, and/or a motion tracking glove.

9. The method according to claim 7, comprising communicating with said one or more auxiliary devices via one or more wireless interfaces.

10. The method according to claim 9, wherein said one or more wireless interfaces comprise wireless personal area network (WPAN) interfaces and/or wireless local area network (WLAN) interfaces.

11. A system comprising:
one or more circuits and/or processor for use in a three-dimensional (3D) video processing device, said one or more circuits and/or processors being operable to:
generate 3D video data representative of a 3D user interface;
display said 3D user interface using said generated 3D video data, wherein said displaying creates a 3D perception within proximity of a user;
track spatial and/or temporal movement of said user relative to said displayed 3D user interface based on said 3D perception; and
control operation of said 3D video processing device based on said tracking.

12. The system according to claim 11, wherein said generated 3D video data comprises stereoscopic left view and right view sequences of reference fields or frames.

13. The system according to claim 11, wherein said one or more circuits and/or processors are operable to composite said generated 3D video data with other video content handled via said 3D video processing device such that said 3D user interface is overlaid on at least a portion of images corresponding to said other video content.

14. The system according to claim 11, wherein said one or more circuits and/or processors are operable to determine a location of said user relative to said 3D video processing device.

15. The system according to claim 14, wherein said one or more circuits and/or processors are operable to generate said 3D video data representative of said 3D user interface such that a perceived location of said 3D user interface of said 3D user interface is based on said determined location of said user.

16. The system according to claim 14, wherein said one or more circuits and/or processors are operable to determine said location of said user, and/or said spatial and/or temporal tracking of movement by said user based on information generated by one or more sensors coupled to said video processing device.

17. The system according to claim 14, wherein said one or more circuits and/or processors are operable to determine said location of said user, and/or said spatial and/or temporal tracking of movement by said user based on information provided by said user and/or by one or more auxiliary devices used by said user.

18. The system according to claim 17, wherein said one or more auxiliary devices comprise an optical viewing device for 3D video viewing, a remote control, and/or a motion tracking glove.

19. The system according to claim 17, wherein said one or more circuits and/or processors are operable to communicate with said one or more auxiliary devices via one or more wireless interfaces.

20. The system according to claim 19, wherein said one or more wireless interfaces comprise wireless personal area network (WPAN) interfaces and/or wireless local area network (WLAN) interfaces.
